(19) United States
(12) Patent Application Publication
(10) Pub. No.: US 2026/0178783 A1
(43) Pub. Date: Jun. 25, 2026

(54) ELECTROMAGNETIC SIDE-CHANNEL COUNTERMEASURES

(71) Applicant: Intel Corporation, Santa Clara, CA (US)

(72) Inventors: Raghavan Kumar, Hillsboro, OR (US); Harish K. Krishnamurthy, Beaverton, OR (US); Sanu K. Mathew, Portland, OR (US); Minxiang Gong, Portland, OR (US)

(21) Appl. No.: 18/990,404

(22) Filed: Dec. 20, 2024

(51) Int. Cl. G06F 21/72; G01R 31/28; G06F 21/75; H01L 23/522; H02M 3/07; H03H 7/01

(52) U.S. Cl. CPC G06F 21/72; G01R 31/2853; G01R 31/2896; G06F 21/75; H02M 3/07; H03H 7/1783; H10W 20/495; H10W 20/496; H03H 7/1708

(57) ABSTRACT

Embodiments herein relate to countermeasures for electromagnetic (EM) probing attacks of voltage regulators (VRs) for cryptographic circuits. In one aspect, the clamp strength of a VR such as a switched-capacitor VR is dynamically and randomly modulated. The VR can include switches for transferring charge, where a switch can include a number of sub-switches in parallel, and the number of active switches is randomly varied to randomize the EM emissions. In another aspect, a capacitor of a VR is formed in a metal wiring layer of an integrated circuit package such as a top metal layer, where the capacitor has inter-digitated electrodes which cancel out current flows to/from the electrodes to reduce EM emissions. In another aspect, a resonant VR includes circuitry to detect changes in current or voltage which correlates with a change in its resonant frequency due to EM probing.

### BACKGROUND

Cryptographic circuits are used in computing devices to store cryptographic information securely. Examples of cryptographic circuits include circuits implementing symmetric key encryption algorithms like AES (Advanced Encryption Standard), asymmetric key encryption algorithms like RSA (Rivest-Shamir-Adleman) or Elliptic Curve Cryptography (ECC), hash functions like SHA-256, and digital signature algorithms like ECDSA (Elliptic Curve Digital Signature Algorithm) which are all built using logic gates to perform complex mathematical operations needed for encryption and decryption processes. However, there is a continuing need to prevent attackers from compromising cryptographic circuits.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts an example Advanced Encryption Standard (AES) accelerator circuit 100, in accordance with various embodiments.

FIG. 2 depicts an example image of a electromagnetic (EM) probe and a wafer containing a cryptographic circuit, in accordance with various embodiments.

FIG. 3 depicts plots of correlation magnitude versus number of traces, in accordance with various embodiments.

FIG. 4 depicts an example cross-sectional view of a package 400 containing a cryptographic circuit, in accordance with various embodiments.

FIG. 5 depicts an example voltage regulator (VR) 500 of a cryptographic circuit in the form of a charge pump configured as a voltage doubler, where one or more switches comprises a number of sub-switches in parallel which can be individually and randomly controlled, in accordance with various embodiments.

FIG. 6 depicts an example voltage regulator 600 of a cryptographic circuit in the form of a charge pump configured with a 1:1.33 ratio, where one or more switches comprises a number of sub-switches in parallel which can be individually and randomly controlled, in accordance with various embodiments.

FIG. 7A depicts a view of a capacitor circuit 700 including a capacitor 705 with inter-digitated electrodes 705E1 and 705E2 in a metal wiring layer of an IC package, in accordance with various embodiments.

FIG. 7B depicts a view of current flows in the capacitor 705 of FIG. 7A, in the y-z plane at x=x0, in accordance with various embodiments.

FIG. 8 depicts an example circuit 800 including a resonant VR 810 and a resonant frequency detector frequency 820, in accordance with various embodiments.

FIG. 9 depicts an inductor-inductor-capacitor (LLC) resonant VR 900 in an example implementation of the resonant VR 810 of FIG. 8, in accordance with various embodiments.

FIG. 10 depicts an example circuit 1000 for measuring current in the VR 900 of FIG. 9 using a current transformer, in accordance with various embodiments.

FIG. 11 illustrates an example of components that may be present in a computing system 1150 for implementing the techniques (e.g., operations, processes, methods, and methodologies) described herein.

### DETAILED DESCRIPTION

As mentioned at the outset, there is a continuing need to prevent attackers from compromising cryptographic circuits.

An attacker can use various types of attacks to obtain information such as a secret key from an integrated circuit (IC). An IC that stores cryptographic or other secret data may be referred to as a cryptographic circuit. A cryptographic circuit may refer to a digital circuit designed specifically to perform cryptographic operations such as encryption or decryption, by utilizing logic gates to manipulate data bits according to a specific cryptographic algorithm, thereby translating the mathematical steps of encryption into a hardware implementation using electronic circuits.

One type of attack is a side-channel attack, where information such as power consumption and electromagnetic (EM) radiation is measured from the circuit while it is operated. This information is referred to as leaked information, and may be correlated to the underlying computations or keys of the circuit. For example, a timing attack can measure computation time such as the time used to perform private key operations and attempt to correlate computation times to reveal information such as fixed Diffie-Hellman exponents, Rivest-Shamir-Adleman (RSA) factors, and other secret parameters of a cryptosystem.

A power analysis attack involves physical measurements, via an external probe, of a circuit's current consumption over time, and attempts to correlate the current consumption with the instructions or data being processed. In Simple Power Analysis (SPA) attacks, the attacker observes the trace of current consumption over time and tries to directly apply it to the underlying cryptographic processing. The attacker collects a large number of power traces for thousands of encryptions using high speed equipment such as modern digital oscilloscopes with high speed analog-to-digital (A/D) capture. Another type of power analysis attack is Differential Power Analysis (DPA) which relies on statistical tests to isolate a signal of interest from noisy and complex power signals on a device.

While power analysis attacks (SPA and DPA) are based on measured power consumption, electromagnetic (EM) attacks are based on measured electromagnetic signals due to currents flowing in the cryptographic circuits.

EM side-channel attacks pose a significant threat to cryptographic hardware accelerators, for instance, with EM radiations directly correlated to current draw from the supply.

One possible solution is to provide isolation between the load current signature and the input supply visible to an attacker. For example, in an integrated voltage regulators (IVR), one possible solution to mitigate EM attacks includes a low-dropout (LDO) voltage regulator coupled with cryptographic hardware augmented with arithmetic countermeasures. LDO transforms the load current signature, providing a significant improvement in side-channel resistance for power SCA attacks. The arithmetic countermeasures provide uniform power and EM side-channel resistance. For example, a masking-based arithmetic countermeasure involves the addition of a pseudo-random mask with input key, thereby breaking the correlation between the data and the corresponding power consumption. While this significantly boosts the side-channel resistance for power consumption-based SCA attacks, the underlying load current perturbations are still visible through EM radiations, rendering the countermeasures ineffective.

The solutions provided herein address the above and other disadvantages. In some aspects, the solutions provide EM leakage suppression of VRs, and EM detection and prevention with top metal (TM) on-chip inductors.

In one aspect, the solutions include dynamic modulation of the clamp strength of a voltage regulator (VR). The clamp strength can refer to the VR's ability to maintain a stable output voltage despite fluctuations in the input voltage. In an example implementation, one or more switches of the VR comprises a number of sub-switches in parallel which can be individually and randomly controlled to turn on or off. In an example implementation, the VR is a switched-capacitor charge pump where the one or more switches are used to transfer charge from an input node to an output node. The dynamic clamp strength modulations can randomize the transition time within or between switches in the VR and thereby alter EM emissions from the circuit to make the attacker's task more difficult.

In another aspect, a capacitor of a VR for a cryptographic circuit is formed in a metal wiring layer of an IC package such as in a top metal layer above a substrate, where the capacitor has inter-digitated electrodes. For example, the capacitor can be a metal-insulator-metal (MiM) capacitor. The capacitor will have out-of-phase current flows which cancel each other out and reduce EM emissions.

In another aspect, a resonant VR of a cryptographic circuit includes associated circuitry to detect changes in the characteristics of the VR, such as current or voltage, which correlate with a change in its resonant frequency due to EM probing by an attacker. The detection of the probing can trigger an alert and/or other action such as stopping an encryption process or shutting down the circuit. The resonant VR may have one or more inductors formed in a metal wiring layer which are susceptible to EM probing.

The solutions provide a number of advantages, including thwarting and detecting an attacker's efforts to obtain highly-sensitive security assets or other data from cryptographic circuits or other circuits in general.

These and other features will be further apparent in view of the following discussion.

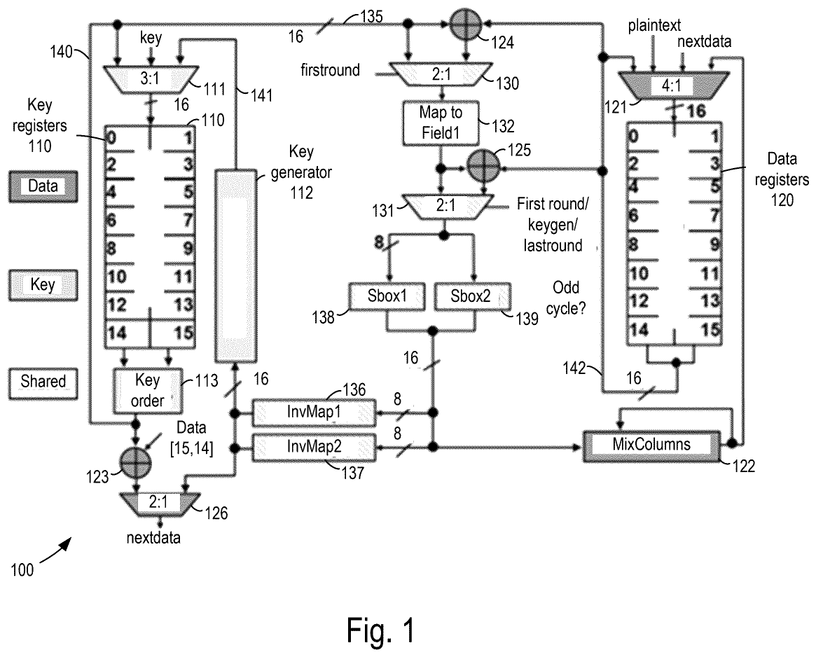

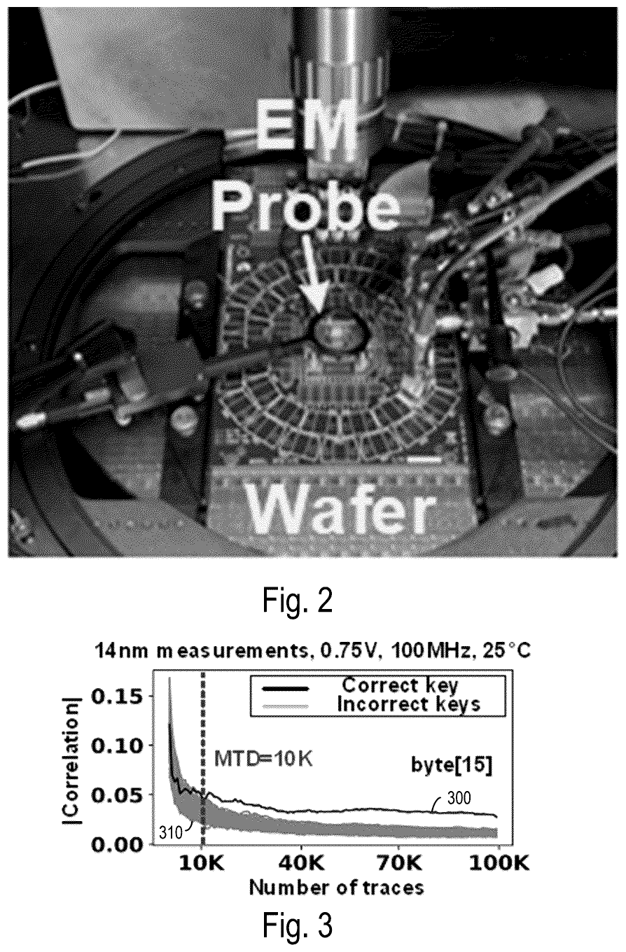

FIG. 1 depicts an example Advanced Encryption Standard (AES) accelerator circuit 100, in accordance with various embodiments. The circuit is a baseline unprotected 16-bit serial AES accelerator. The circuit was evaluated for EM side-channel attack vulnerabilities using the wafer-probed experimental of FIG. 2 which collect EM traces.

An AES circuit works by performing multiple rounds of a series of operations on a block of data, including substitution, permutation, and mixing with a round key, using a predefined lookup table (S-box) to scramble the data, making it extremely difficult to decrypt without the correct key. It performs a complex series of transformations applied to the data in a specific order to encrypt it, with each round adding more complexity to the encryption process by combining the data with a portion of the secret key.

The circuit 100 includes shared components, key components, data components, and other components. The shared components include 2:1 multiplexers 130 and 131, a MaptoField1 block 132, Sbox1 138 and Sbox2 139, and InvMap1 block 136 and InvMap2 block 137. The key components include a 3:1 multiplexer 111 (mux), a key generator 112, and a key order 113. The data components include a 4:1 mux 121, a MixColumns block 122, adders 123, 124 and 125, and a 2:1 mux 126. The other components include a key register 110 and data registers 120.

The multiplexer 121 receives an output from the data registers 120 on a path 142, plaintext, nextdata (output from mux 126), and an output from the MixColumns block 122, and provides a 16-bit value to the data registers 120. MixColumns refers to a specific operation where each column of a state matrix is multiplied with a fixed matrix using a special multiplication based on the Galois Field (GF(2\hat{ }8)).

The output of the data registers 120 is input to the adders 124 and 125. The mux 130 receives an output of the adder 124 and data on the path 135, and provides an output to the MaptoField1 block 132. Map to field refers to the process of representing data (typically bytes) as elements of a specific finite field, e.g., the Galois field GF(2\hat{ }8), which is the mathematical foundation for AES operations.

The MaptoField1 block 132 provides an output to the 2:1 mux 131 and the adder 125. The mux 131 provides an output to Sbox1 and Sbox2 which are first and second lookup tables, respectively. “Sbox” refers to a “Substitution Box,” which is a component that performs a non-linear transformation on a block of 8 bits (a byte) of data. It replaces each input byte with a unique pre-defined output byte based on a lookup table. Outputs of Sbox1 and Sbox2 are provided to the MixColumns block 122, the InvMap1 block and the InvMap2 block. Outputs of the InvMap1 block and the InvMap2 block are provided to the key generator 112 and the 2:1 mux 126.

The mux 111 receives an output of the key order 113 on a path 140 and an output of the key generator on a path 141, and provides an output to the key registers 110. The key registers are dedicated storage locations that hold the encryption key, which is then expanded into multiple round keys used during each round of the encryption process. The key registers provide outputs to the key order, which provides an output to an adder 123 and the path 140. The adder also receives data[15,14].

FIG. 2 depicts an example image of a electromagnetic (EM) probe and a wafer containing a cryptographic circuit, in accordance with various embodiments. A Langer RF2 (Langer EMV-Technik GmbH, Bannewitz, Germany) and Micro Field Analysis (MFA) probe was used to collect EM emissions from the chip. The chip was scanned for peak EM emission locations using the high-resolution MFA probe (200 μm). EM signatures were captured at a clock frequency of 100 MHz at 0.75V to mitigate any process-related advantages. The signatures were averaged over 16 iterations with identical inputs to improve the signal-to-noise ratio (SNR).

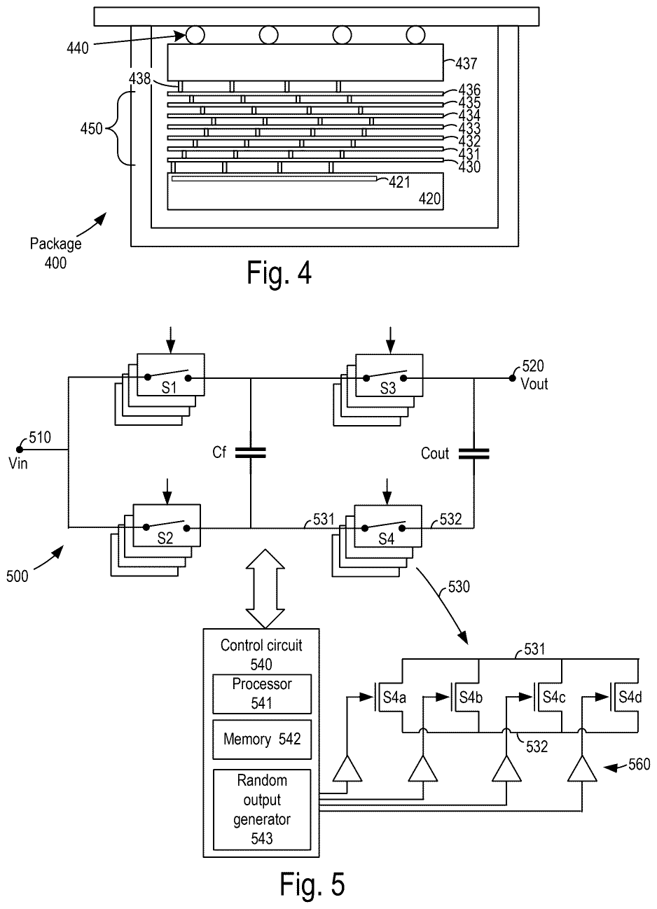

FIG. 3 depicts plots of correlation magnitude versus number of traces, in accordance with various embodiments. The plot 300 depict the case of a correct key and the combined plots 310 depict the case of incorrect keys. Correlation EM analysis (CEMA) on unprotected AES using hamming weight (HW) of Sbox outputs as the power model shows the minimum number of traces to disclose (MTD) of the first extracted key byte to be 10K traces, indicating the potency of EM attacks. The metal layers (especially the top metal layer, see FIG. 4) act as an antenna and emits EM radiation which directly depends on the input data. Conventional low-dropout (LDO) regulators hide the load current signatures from the input supply, resulting in improved side-channel resistance for power-based SCA attacks. However, the power supply rails for the load supply on the higher metal layers emit EM radiations, that can be picked by the EM probe. The EM signatures will contain information about the underlying load perturbations, that are directly dependent on the secret key. A CEMA attack on the resulting EM signatures can reveal secret key bytes, compromising the security of cryptosystem.

FIG. 4 depicts an example cross-sectional view of a package 400 containing a cryptographic circuit, in accordance with various embodiments. The package includes a silicon substrate 420 on which a cryptographic circuit 421 such as an AES accelerator is disposed. A number of top metal layers, also referred to as wiring layers, are disposed above the substrate. For example, a set of metal layers 450 includes first through eighth metal layers 430-437, respectively. The layer 437 is the topmost metal layer. The metal layers generally are thicker further away from the substrate, so that the topmost metal layer is the thickest. Additionally, some components of the cryptographic circuit 421 may be formed in one or more of the metal layers, such as inductors and capacitors. This approach saves space on the substrate and takes advantage of the metal properties which are desirable for capacitors and inductors. The components in the top metal layers are susceptible to EM probing by an attacker. The topmost metal layer 437 may be electrically coupled from above by balls 440 or other connectors to external contacts of the package.

In some cases, bottom metal layers are provided below the substrate, typically for power delivery to circuits on the substrate. In theory, components of the cryptographic circuit such as inductors and capacitors could be included in the bottom metal layers. The metal layers are coupled to one another and to the cryptographic circuit 421 by vias which extend vertically in the package. An example via 438 is denoted. In one approach, a via extends between adjacent metal layers and multiple vias can be stacked one atop the other or otherwise electrically coupled to provide a path to the substrate of between non-adjacent metal layers. In another approach, a single via can extend through the multiple metal layers.

FIG. 5 depicts an example voltage regulator (VR) 500 of a cryptographic circuit in the form of a charge pump configured as a voltage doubler, where one or more switches comprises a number of sub-switches in parallel which can be individually and randomly controlled, in accordance with various embodiments. A charge pump converter is a type of direct current (DC)/DC voltage converter that uses capacitors to raise or lower voltages.

The VR includes an input node 510 which receives Vin, an output node 520 which provides Vout=2×Vin, a flying capacitor Cf, switches S1-S4, and an output capacitor Cout. Each of the switches can include a set of sub-switches which are coupled in parallel. For example, the arrow 530 shows that the switch S4 can include sub-switches S4a, S4b, S4c and S4d coupled in parallel between nodes 531 and 532. In other words, the switch (switch block or group) S4 represents a set of switches.

In the VR 500, Cf is charged by the input node and discharge to the output node. In a charging phase, S1 and S4 are turned on (made conductive) while S2 and S3 are off (non-conductive). This allows the input voltage to charge Cf. A conversion stage is next. In this stage, S1 and S4 turn off, while S2 and S3 turn on since the voltage across the capacitor does not change immediately. Cf then discharges to the output capacitor. The charging and discharging are repeated in consecutive charge-discharge cycles or periods at a specified frequency, where each cycle includes charging and discharging.

The sub-switches can be individually controlled by signals from a control circuit 540. For example, the sub-switches may be metal-oxide-semiconductor field-effect transistors (MOSFETs) which have their control gates coupled to the control circuit to receive on/off voltages. The control circuit 540 can include a memory 542 to store instructions and a processor 541 to execute the instructions to provide the functions described herein. The control circuit 540 may further include a random number generator 543 which generates one or more numbers for use during each charge/discharge period. Each number can be in the range of one to the number of sub-switches, e.g., four, in this example.

One factor that determines the strength of the EM radiation from a cryptographic circuit is the transition time of the switching. The faster the switching of the signals, the stronger and more detectable these emissions become. This approach uses dynamic VR clamp strength modulations to mitigate EM from switching of the VR. One or more switches in the charge pump each has multiple sub-switches pieces controlled by their own drivers. For example, a set of drivers 560, under the control of the control circuit, can be used to drive the sub-switches S4a-S4d.

Turning on fewer sub-switches leads to a higher resistance in the path, increasing the resistance-capacitance (RC) time constant, hence affecting the charging and discharging time. As a result, the portion of the VR which is in the top metal, e.g., the capacitors, will see smaller current steps, and the EM can be reduced. For example, the capacitors can be metal-insulator-metal (MiM) capacitors formed in one or more metal layers. Moreover, the transition time can be dynamically randomized in real time to protect the key information leakage. The randomizing can be within the different sub-switches of one switch and/or between different switches.

A number of implementations are possible to randomize the EM signature of the VR. For example, one random number can be used for each of the switches which is to be randomly controlled. If the random number is three, for example, three sub-switches are turned on/off for each of the switches S1-S4. That is, the sub-switches are active or selected. In one approach, one or more of the switches but fewer than all of the switches are randomly controlled. For example, S1 and S4 may be randomly controlled and each include four sub-switches while S2 and S3 may include only a single switch with no sub-switches. In another approach, different switches include a different number of sub-switches. For example, S1 can include two sub-switches and S2 can include four sub-switches. In another approach, the random number is used for two or more consecutive one charge/discharge period rather than changing for each charge/discharge period. Other variations are possible as well.

The random generator is meant to encompass a truly random output, a pseudorandom output, and/or a hybrid output.

A true random number generator (TRNG) uses unpredictable physical phenomena to generate random numbers. It is non-deterministic and its output depends on the physical process, ensuring true randomness. Examples of physical phenomena used include thermal noise, e.g., resistor or diode noise, radioactive decay, photon emission or scattering, and jitter in oscillators, e.g., variability in clock signals. Examples implementations include amplifiers with noise as input (e.g., using Zener diodes for noise sources), oscillator sampling with jitter (e.g., sampling high-frequency oscillators with slower clocks), and entropy harvesting circuits. An entropy harvesting circuit is a specialized electronic circuit designed to capture and convert naturally occurring randomness from physical phenomena like thermal noise, clock jitter, or other unpredictable fluctuations into a usable stream of random bits, essentially harvesting the entropy (disorder) present in the environment to generate truly random numbers

A Pseudo-Random Number Generator (PRNG) uses deterministic algorithms to generate sequences of numbers that appear random. Its output depends on an initial seed value, and is reproducible if the seed and algorithm are known. This approach can be used for applications where high speed and repeatability are required. Example implementations use a linear Feedback Shift Register (LFSR), a cellular automata, and algorithmic methods (e.g., linear congruential generators, Mersenne Twister).

A Hybrid Random Number Generator combines a TRNG and a PRNG to enhance performance and randomness. In one approach, a TRNG is used to provide entropy or a seed for a PRNG.

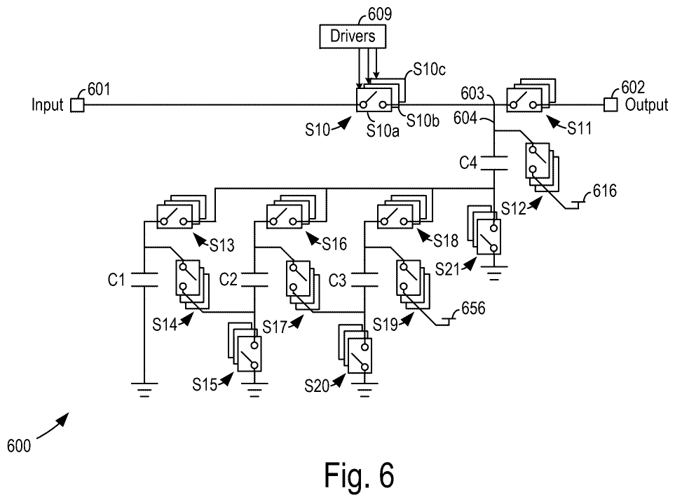

FIG. 6 depicts an example voltage regulator 600 of a cryptographic circuit in the form of a charge pump configured with a 1:1.33 ratio, where one or more switches comprises a number of sub-switches in parallel which can be individually and randomly controlled, in accordance with various embodiments. The VR includes an input node 601 and an output node 602 which provides Vout=Vin×1.33. A numbers of switches S10-S19 are depicted, where each includes multiple sub-switches. For example, S10 includes sub-switches S10a, S10b and S10c which are controllers by respective drivers 609. S10 is between nodes 601 and 603, and S11 is between nodes 603 and 602. A path 604 extends from the node 603 into a number of grounded sub-paths. The path 604 includes S21 and C4. A first sub-path includes C1 and S13, a second sub-path includes S15 (coupled to the first path by S14), C2 and S16, and a third sub-path includes S20 (coupled to the second path by S17), C3 and S18. S12 and S19 may be coupled to power supply nodes 616 and 656, respectively, to reeve a power supply voltage Vdd. In operation, charge is transferred from the input node to the capacitor C4 and the capacitors below it, and from C4 to the output node 602.

FIGS. 5 and 6 are just two example of VRs which can employ randomized switching. Generally, any type of switched VR can be used.

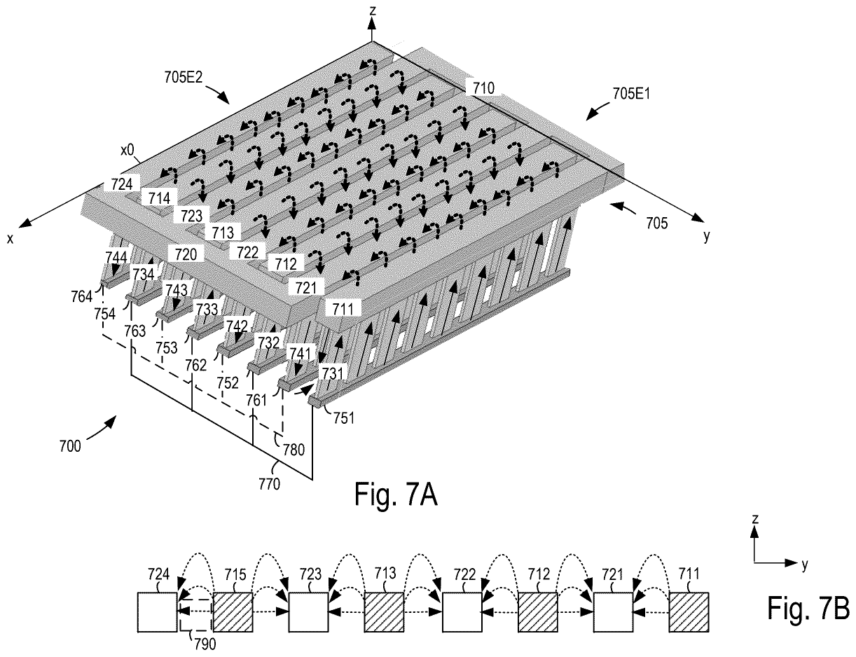

FIG. 7A depicts a view of a capacitor circuit 700 including a capacitor 705 with inter-digitated electrodes 705E1 and 705E2 in a metal wiring layer of an IC package, in accordance with various embodiments. Physical isolation is another effective way to reduce EM emissions used by attackers. However, metal shielding or guarding is not applicable when no metal layer above the top metal layers is available. This figure shows a phase-arrayed layout strategy to prevent or reduce EM emissions. A MiM capacitor is formed in a top metal layer are arranged to have top and bottom plates/electrodes next to each other. During the operation of a circuit which includes the capacitor, a current flows from lower metal layers to a first electrode of the capacitor through a first set of rows of vias, and then flows from first electrode to a second electrode as a displacement current and then to the lower metal layers through a second set of rows of vias. As a result, adjacent current flows are 180 degree out-of-phase, and the magnetic fields they generate can interfere destructively.

In an example implementation, the electrodes are in a single wiring layer, such as a top wiring layer. The first electrode 705E1 includes a base portion 710 and number of fingers 711, 712, 713 and 714, which extend perpendicular to the base portion 710. Similarly, the second electrode 705E2 includes a base portion 720 and number of fingers 721, 722, 723 and 724, which extend perpendicular to the base portion 720. The fingers of the electrodes may extend parallel to one another and be separated by an insulating material.

The capacitor 705 can be considered to be a single capacitor which is made up from different individual capacitors formed from adjacent fingers. The capacitor 705 is an example of one of the capacitors in the VRs of FIG. 5 or 6 or other switched-capacitor VR or other circuit.

The capacitor circuit 700 extends in an x-y plane, parallel to a substrate which includes other portions of a cryptographic circuit. Vias extend in the z direction to couple conductive paths which extend in the x direction to the capacitor fingers. For example, the conductive paths 751, 752, 753 and 754 are coupled to the fingers 711, 712, 713 and 714 by a first set of rows of vias 731, 732, 733 and 734, respectively, and the conductive paths 761, 762, 763 and 764 are coupled to the fingers 721, 722, 723 and 724 by a second set of rows of vias 741, 742, 743 and 744, respectively.

In an example implementation, the conductive paths 751, 752, 753 and 754 are coupled to one another by a path 770, and the conductive paths 761, 762, 763 and 764 are coupled to one another by a path 780. The conductive paths may be on the substrate or on a lower metal wiring layer than the metal wiring layer which includes the capacitor.

The up or down arrows on the vias denote an example direction of current to/from the capacitor electrodes during the operation of a circuit such as a VR. For example, the up arrows on the vias 731, 732, 733 and 734 denote current going to the fingers of the electrode 705E1, and the down arrows on the vias 741, 742, 743 and 744 denote current going away from the fingers of the electrode 705E2. The current which reaches the fingers of the electrode 705E1 from the conductive paths 751, 752, 753 and 754 can move toward an adjacent finger of the electrode 705E2 through a displacement current (represented by curved dashed-line arrows) and return to the conductive paths 761, 762, 763 and 764.

The first and second electrodes can have a same number of fingers, e.g., four in this example.

FIG. 7B depicts a view of current flows in the capacitor 705 of FIG. 7A, in the y-z plane at x=x0, in accordance with various embodiments. For clarity, the fingers 711, 712, 713 and 714 of the first electrode 705E1 are depicted with a cross-hatch pattern and the fingers 721, 722, 723 and 724 of the second electrode 705E2 are unpatterned. The dashed-line arrows depict a displacement current which occurs when the capacitor is charging or discharging. A displacement current occurs between adjacent fingers. For example, a displacement occurs from the fingers 711 and 712 to the finger 721. A displacement occurs from the fingers 712 and 713 to the finger 722. A

displacement occurs from the fingers 713 and 715 to the finger 723. A displacement occurs from the finger 715 to the finger 724.

The fingers are spaced apart and separated by an insulator such as the example insulator 790 between fingers 715 and 724. The fingers may be spaced apart by equal distances.

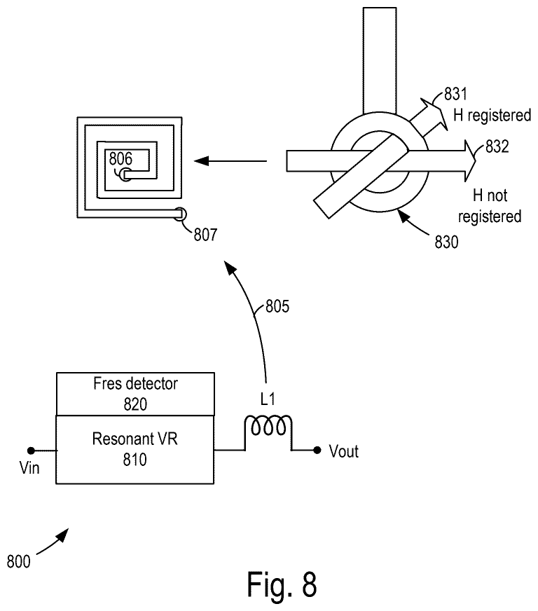

FIG. 8 depicts an example circuit 800 including a resonant VR 810 and a resonant frequency detector frequency 820, in accordance with various embodiments. A resonant VR is a type of power regulation device that uses the principle of resonance in electrical circuits to regulate output voltage. It typically involves components such as inductors, capacitors, and transformers arranged in a resonant circuit to provide a stable output voltage, even in the presence of input voltage fluctuations or varying load conditions.

The VR operates based on the resonance phenomenon. At a specific frequency (the resonant frequency), the inductive reactance and capacitive reactance in a circuit cancel each other out, minimizing impedance and allowing maximum power transfer. By maintaining the operation of the circuit at or near its resonant frequency, the output voltage is stabilized. One example of a resonant VR is an inductor-inductor-capacitor (LLC) VR. Other types of resonant circuits include, e.g., an LC circuit, an LLCC circuit, and so forth.

The resonant VR 810 receives Vin and provides a voltage Vout via an example inductor L1. The arrow 805 indicates L1 can be formed from a spiral shaped metal path in a metal wiring layer, in an example implementation. Vias 806 and 807 may be coupled to opposing ends of the inductor to couple the inductor to a remainder of the circuit on the substrate. An attacker can position the EM probe 830 close to the inductor an attacker to detect its EM emissions. The probe generates a magnetic vector (H) 831 which is registered and a perpendicular magnetic vector 832 which is not registered.

In an example implementation, the frequency detector frequency 820 is used to detect variations in characteristics of the VR, such as current and/or voltage, which indicate a change in the resonant frequency of the VR. This change in turn can be indicative of EM probing of the VR. A corresponding action can be performed such as triggering an alert and/or shutting down the VR.

A resonant VR provides an efficiency boost as well as preventing EM probing. An inductor, which can be realized by a top metal layer, at the output node can be used for resonant operation in the VR. The VR operates at a resonant frequency of Fres=1/(2π√LC), which is related to its topology-equivalent RC. In an example implementation, a resonant frequency detector/calculator is added to the VR to monitor Fres. Due to magnetic coupling, the RF probe, placed close to the top metal by an attacker, will change the inductor's value. As a result, fres is changed, and the detector/calculator can notice the frequency shifting. A warning can be sent out to perform an action such as stopping an encryption process or performing a countermeasure.

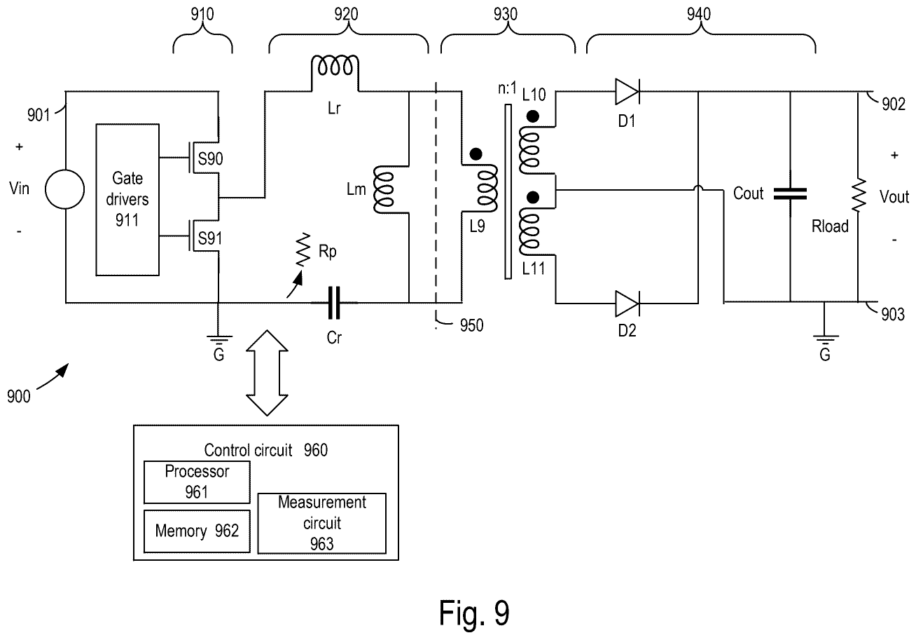

FIG. 9 depicts an inductor-inductor-capacitor (LLC) resonant VR 900 in an example implementation of the resonant VR 810 of FIG. 8, in accordance with various embodiments. The VR include an input node 901, an output node 902 and a ground node 903, and is made up of 4 blocks. A first block 910 includes power switches S90 and S91 which are driven by gate drivers 911. A second block 920 is a resonant tank which includes a series resonant inductor Lr, a parallel inductor Lm, and a series resonant capacitor Cs, a third block 930 is a transformer which includes inductors L9, L10 and L11 in an n:1 windings ratio, and a fourth block 940 is a diode rectifier which includes diodes D1 and D2 and an output capacitor Cout. The load at the output node is depicted by a resistance Rload.

In operation, the MOSFET power switches convert the input DC voltage into a high-frequency square wave. This square wave then enters the resonant tank, which eliminates the square wave's harmonics and outputs a sine wave of the fundamental frequency. The sine wave is transferred to the secondary of the converter through a high-frequency transformer, which scales the voltage up or down, according to the application. Lastly, the diode rectifier converts the sine wave into a stable DC output.

The example VR is a half-bridge converter with a full wave rectifier. Another example of a resonant VR is a full-bridge converter with a bridge rectifier.

Generally, the VR can have two different resonant frequencies. A first, fixed resonant frequency is fr=1/[2π√(Cr*Lr)]. A second resonant frequency, with varies with the load, is fm=1/{2π√[Cr*(Lr+Lm)]}.

A control circuit 960 can communicate with the VR 900 such as to monitor the input and output voltage, control the gate drivers and monitor characteristics of the VR such as current and/or voltage which are indicative of a change in the resonant frequency (fr and/or fm) of the VR. The control circuit can include a memory 962 which stores instructions to be executed by a processor 961 to provide the features described herein. The control circuit can include a measurement circuit 963 to measure characteristics of the VR such as current and/or voltage.

For example, three techniques for measuring the current include using a power resistance with a small tolerance, using a current transformer, and measuring the resonant tank current directly using a current probe.

A power resistance with a small tolerance refers to a resistor designed to handle high power levels while also having a very precise resistance value. This approach involves placing the resistor (Rp) in series with other components in the resonant loop (e.g., Lr, Lm and/or Cr in the resonant tank). The resistance should have a high resolution and good temperature performance. Normally, the resonant loop is connected to ground by one terminal, which can reduce common mode noise when measured. This approach provides a straightforward way to measure resonant tank current but had disadvantages such as increasing power loss, especially at high current Also, it changes the resonant parameter and makes the operation deviate from the original design.

The use of a current transformer is discussed next.

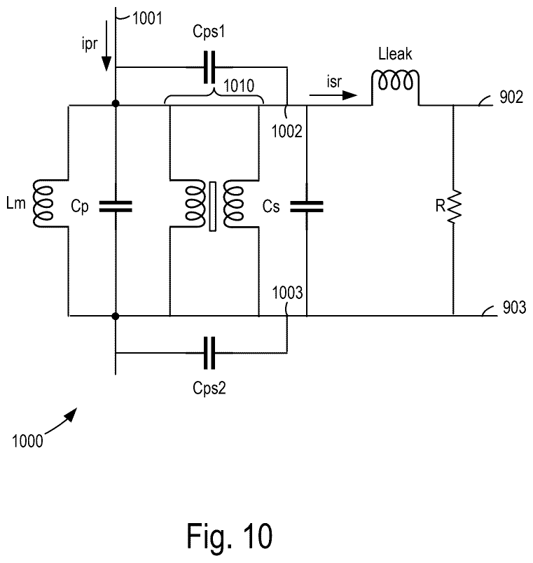

FIG. 10 depicts an example circuit 1000 for measuring current in the VR 900 of FIG. 9 using a current transformer, in accordance with various embodiments. The circuit can be placed at the location of the dashed line 950 in FIG. 9. The circuit includes a path 1001 having a capacitance Cp, representing the parasitic capacitance of the primary side, and having a current ipr. Cp is in series with a transformer 1010 and Cs, parasitic capacitance of the secondary side. The transformer provides a current isr through a leakage inductor lleak, and a sample resistance R is between the nodes 902 and 903. Because the secondary leakage inductance is much larger than the primary leak inductance, leakage inductance is set at the secondary side. A parasitic capacitance between primary turns and secondary turns is represented by Cps1 which is coupled between the path 1001 and a node 1002, and by Cps2 which is coupled between the path 1001 and a node 1003.

In this approach, the primary side is in series in the resonant loop. Compared with the use of a power resistance, this approach has low resistance and its power loss is lower than the power resistance. Moreover, compared with Lr and Lm of the resonance loop, the magnetic inductance of the current transformer is small and can be ignored. However, the current transformer approach has disadvantages because of parasitic parameters.

A third technique for measuring the current in the VR 900 is to measure resonant tank current directly by an ammeter which his in series with other components in the resonant loop.

In one approach, the VR is tested during the manufacturing stage to determine one or more characteristic associated with its resonant frequency. The determine characteristics can be stored in the control circuit 960 for later use when the device is in the hands of the end user. At this time, the control circuit can detect the one or more characteristic during operation of the VR and compare them to the stored characteristics. An action can be taken if a deviation is detected which is indicative of EM probing of the VR.

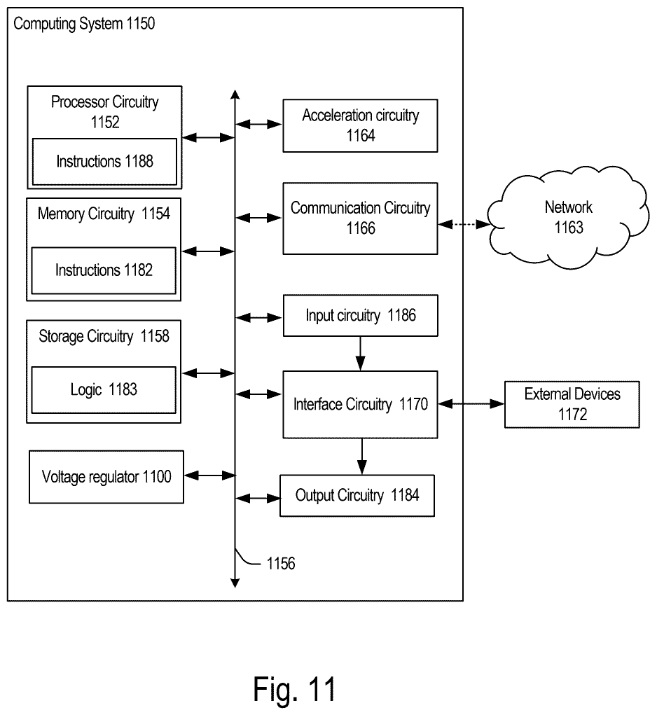

FIG. 11 illustrates an example of components that may be present in a computing system 1150 for implementing the techniques (e.g., operations, processes, methods, and methodologies) described herein.

The computing system 1150 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1150, or as components otherwise incorporated within a chassis of a larger system. In an example implementation, the voltage regulator 1100 represents one or more of the VRs as discussed herein, and the other circuitry can represent one or more load die, including a cryptographic circuit, which are powered by the VR. In one approach, all or part of the computing system 1150 is provided in a SoP, System in Package (SiP) or a System on Chip (SoC).

The voltage regulator can provide a voltage Vout to one or more of the components of the computing system 1150. The memory circuitry 1154 may store instructions and the processor circuitry 1152 may execute the instructions to perform the functions described herein.

The system 1150 includes processor circuitry in the form of one or more processors 1152. The processor circuitry 1152 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1152 may include one or more hardware accelerators (e.g., same or similar to acceleration circuitry 1164), which may be microprocessors, programmable processing devices (e.g., FPGA, ASIC, etc.), or the like. The one or more accelerators may include, for example, computer vision and/or deep learning accelerators. In some implementations, the processor circuitry 1152 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor circuitry 1152 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 1152 may be coupled with or may include memory/storage and may be configured to execute instructions stored in the memory/storage to enable various applications or operating systems to run on the platform 1150. The processors (or cores) 1152 is configured to operate application software to provide a specific service to a user of the platform 1150. In some embodiments, the processor(s) 1152 may be a special-purpose processor(s)/controller(s) configured (or configurable) to operate according to the various embodiments herein.

As examples, the processor(s) 1152 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1152 may be a part of a system on a chip (SoC), System-in-Package (SiP), a multi-chip package (MCP), and/or the like, in which the processor(s) 1152 and other components are formed into a single integrated circuit, or a single package, such as the Edison™ or Galileo™ SoC boards from Intel® Corporation. Other examples of the processor(s) 1152 are mentioned elsewhere in the present disclosure.

The system 1150 may include or be coupled to acceleration circuitry 1164, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1164 may comprise logic blocks or logic fabric and other interconnected resources that may be programmed (configured) to perform various functions, such as the procedures, methods, functions, etc. of the various embodiments discussed herein. In such implementations, the acceleration circuitry 1164 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1152 and/or acceleration circuitry 1164 may include hardware elements specifically tailored for machine learning and/or artificial intelligence (AI) functionality. In these implementations, the processor circuitry 1152 and/or acceleration circuitry 1164 may be, or may include, an AI engine chip that can run many different kinds of AI instruction sets once loaded with the appropriate weightings and training code. Additionally or alternatively, the processor circuitry 1152 and/or acceleration circuitry 1164 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1152 and/or acceleration circuitry 1164 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin provided by Huawei®, and/or the like. In some hardware-based implementations, individual subsystems of system 1150 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 1150 also includes system memory 1154. Any number of memory devices may be used to provide for a given amount of system memory. As examples, the memory 1154 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1154 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1154 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1158 provides persistent storage of information such as data, applications, operating systems and so forth. In an example, the storage 1158 may be implemented via a solid-state disk drive (SSDD) and/or high-speed electrically erasable memory (commonly referred to as “flash memory”). Other devices that may be used for the storage 1158 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1154 and/or storage circuitry 1158 may also incorporate three-dimensional (3D) cross-point (XPOINT) memories from Intel® and Micron®.

The memory circuitry 1154 and/or storage circuitry 1158 is/are configured to store computational logic 1183 in the form of software, firmware, microcode, or hardware-level instructions to implement the techniques described herein. The computational logic 1183 may be employed to store working copies and/or permanent copies of programming instructions, or data to create the programming instructions, for the operation of various components of system 1150 (e.g., drivers, libraries, application programming interfaces (APIs), etc.), an operating system of system 1150, one or more applications, and/or for carrying out the embodiments discussed herein. The computational logic 1183 may be stored or loaded into memory circuitry 1154 as instructions 1182, or data to create the instructions 1182, which are then accessed for execution by the processor circuitry 1152 to carry out the functions described herein. The processor circuitry 1152 and/or the acceleration circuitry 1164 accesses the memory circuitry 1154 and/or the storage circuitry 1158 over the interconnect (IX) 1156. The instructions 1182 direct the processor circuitry 1152 to perform a specific sequence or flow of actions, for example, as described with respect to flowchart(s) and block diagram(s) of operations and functionality depicted previously. The various elements may be implemented by assembler instructions supported by processor circuitry 1152 or high-level languages that may be compiled into instructions 1188, or data to create the instructions 1188, to be executed by the processor circuitry 1152. The permanent copy of the programming instructions may be placed into persistent storage devices of storage circuitry 1158 in the factory or in the field through, for example, a distribution medium (not shown), through a communication interface (e.g., from a distribution server (not shown)), over-the-air (OTA), or any combination thereof.

The IX 1156 couples the processor 1152 to communication circuitry 1166 for communications with other devices, such as a remote server (not shown) and the like. The communication circuitry 1166 is a hardware element, or collection of hardware elements, used to communicate over one or more networks 1163 and/or with other devices. In one example, communication circuitry 1166 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1166 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1156 also couples the processor 1152 to interface circuitry 1170 that is used to connect system 1150 with one or more external devices 1172. The external devices 1172 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1150, which are referred to as input circuitry 1186 and output circuitry 1184. The input circuitry 1186 and output circuitry 1184 include one or more user interfaces designed to enable user interaction with the platform 1150 and/or peripheral component interfaces designed to enable peripheral component interaction with the platform 1150. Input circuitry 1186 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1184 may be included to show information or otherwise convey information, such as sensor readings, actuator position(s), or other like information. Data and/or graphics may be displayed on one or more user interface components of the output circuitry 1184. Output circuitry 1184 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1150. The output circuitry 1184 may also include speakers and/or other audio emitting devices, printer(s), and/or the like. Additionally or alternatively, sensor(s) may be used as the input circuitry 1184 (e.g., an image capture device, motion capture device, or the like) and one or more actuators may be used as the output device circuitry 1184 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1150 may communicate over the IX 1156. The IX 1156 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1156 may be a proprietary bus, for example, used in a SoC based system.

The number, capability, and/or capacity of the elements of system 1150 may vary, depending on whether computing system 1150 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1150 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: one or more switches coupled between an input node and an output node, wherein a respective switch of the one or more switches comprises a plurality of sub-switches in parallel; one or more capacitors coupled to the one or more switches; and a control circuit coupled to control gates of the one or more switches including the plurality of sub-switches, wherein the control circuit comprises a random number generator.

Example 2 includes the apparatus of Example 1, wherein the control circuit is configured to control a number of active sub-switches in the respective switch based on the random number generator.

Example 3 includes the apparatus of Example 1 or 2, wherein the control circuit is configured to turn on a different number of sub-switches in the respective switch based on the random number generator in different charge-discharge periods.

Example 4 includes the apparatus of any one of Examples 1-3, wherein the apparatus comprises a switched-capacitor voltage regulator.

Example 5 includes the apparatus of any one of Examples 1-4, wherein the control circuit is coupled separately to control gates of different sub-switches of the plurality of sub-switches.

Example 6 includes the apparatus of any one of Examples 1-5, wherein the random number generator is configured to indicate a number of sub-switches of the plurality of sub-switches to turn on in different charge-discharge periods.

Example 7 includes the apparatus of any one of Examples 1-6, wherein: respective switches of the one or more switches each comprise a plurality of sub-switches in parallel; and the control circuit is configured to turn on a different number of sub-switches in different switches of the respective switches based on the random number generator in a same charge-discharge period.

Example 8 includes the apparatus of any one of Examples 1-7, wherein the apparatus is provided in at least one of an integrated circuit, a System on Chip, a System in Package or a computing device.

Example 9 includes an apparatus, comprising: a substrate comprising a circuit; one or more metal layers above the substrate; and a capacitor in a respective metal layer of the one or more metal layers, wherein the capacitor comprises inter-digitated first and second electrodes; vias coupled between the first and second electrodes and the circuit.

Example 10 includes the apparatus of Example 9, wherein: the first electrode comprises fingers coupled to a respective base portion; the second electrode comprises fingers coupled to a respective base portion; a first set of respective rows of vias are coupled to respective fingers of the first electrode; and a second set of respective rows of vias are coupled to respective fingers of the second electrode.

Example 11 includes the apparatus of Example 10, wherein the respective rows of the first set of respective rows alternate with the respective rows of the second set of respective rows.

Example 12 includes the apparatus of Example 10 or 11, wherein the first set of respective rows of vias are coupled together, and the second set of respective rows of vias are coupled together.

Example 13 includes the apparatus of any one of Examples 9-12, wherein adjacent fingers of the first and second electrodes are separated by an insulator.

Example 14 includes the apparatus of any one of Examples 9-13, wherein the capacitor is a switched-capacitor of a voltage regulator.

Example 15 includes a system, comprising: a processor; a resonant voltage regulator (VR) coupled to the processor, the resonant VR including a portion of a substrate and an inductor in a metal layer above the substrate; and a control circuit coupled to the resonant voltage regulator to monitor a current of the resonant VR, wherein the control circuit is configured to determine whether the inductor is subject to electromagnetic probing based on the monitoring.

Example 16 includes the system of Example 15, wherein: the resonant VR comprises an inductor-inductor-capacitor (LLC) resonant VR including power switches, a resonant tank which includes a series resonant inductor, a parallel inductor, and a series resonant capacitor, a transformer and a diode rectifier; and the control circuit is configured to monitor the current in a resistor in series with at least one of the series resonant inductor, the parallel inductor, or the series resonant capacitor.

Example 17 includes the system of Example 15 or 16, wherein: the resonant VR comprises a resonant tank which includes a series resonant inductor, a parallel inductor, and a series resonant capacitor; and the control circuit is configured to monitor the current in the resonant tank.

Example 18 includes the system of any one of Examples 15-17, wherein: the resonant VR comprises an inductor-inductor-capacitor (LLC) resonant VR including power switches, a resonant tank which includes a series resonant inductor, a parallel inductor, and a series resonant capacitor, a transformer and a diode rectifier; and the control circuit is configured to monitor the current in the resonant tank.

Example 19 includes the system of any one of Examples 15-18, wherein the resonant VR comprises a current transformer, and the control circuit is configured to monitor the current in the current transformer.

Example 20 includes the system of any one of Examples 15-19, wherein the control circuit is configured to trigger an alert if the monitoring indicates the inductor is subject to electromagnetic probing.

Example 21 includes a method, comprising: receiving an input voltage at an input node of a switched-capacitor voltage regulator; and controlling a plurality of switches to transfer charge from the input node to an output node via one or more capacitors, wherein at least one respective switch of the plurality of switches comprises a plurality of sub-switches in parallel, and the controlling comprises randomly activating a different number of sub-switches of the plurality of sub-switches in successive charge-discharge periods of the voltage regulator.

Example 22 includes an apparatus, comprising means to perform the method of Example 21.

Example 23 includes a machine-readable storage including machine-readable instructions which, when executed, cause a computer to implement the method of Example 21.

Example 24 includes a computer program comprising instructions which, when executed by a computer, cause the computer to carry out the method of Example 21.

Example 25 includes a method, comprising: receiving an input voltage at an input node of a resonant voltage regulator (VR); transforming the input voltage to an output voltage at an output node; monitoring a current of the resonant VR; and determining whether the resonant VR is subject to electromagnetic probing based on the monitoring.

Example 26 includes the method of Example 25, wherein: the resonant VR comprises a resonant tank which includes a series resonant inductor, a parallel inductor, and a series resonant capacitor; and the monitored current is a current in the resonant tank.

Example 27 includes the method of Example 25, wherein the resonant VR comprises a current transformer, and the monitored current is a current in the current transformer.

Example 28 includes an apparatus, comprising means to perform the method of any one of Examples 25-27.

Example 29 includes a machine-readable storage including machine-readable instructions which, when executed, cause a computer to implement the method of any one of Examples 25-27.

Example 30 includes a computer program comprising instructions which, when executed by a computer, cause the computer to carry out the method of any one of Examples 25-27.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
one or more switches coupled between an input node and an output node, wherein a respective switch of the one or more switches comprises a plurality of sub-switches in parallel;
one or more capacitors coupled to the one or more switches; and
a control circuit coupled to control gates of the one or more switches including the plurality of sub-switches, wherein the control circuit comprises a random number generator.

2. The apparatus of claim 1, wherein the control circuit is configured to control a number of active sub-switches in the respective switch based on the random number generator.

3. The apparatus of claim 1, wherein the control circuit is configured to turn on a different number of sub-switches in the respective switch based on the random number generator in different charge-discharge periods.

4. The apparatus of claim 1, wherein the apparatus comprises a switched-capacitor voltage regulator.

5. The apparatus of claim 1, wherein the control circuit is coupled separately to control gates of different sub-switches of the plurality of sub-switches.

6. The apparatus of claim 1, wherein the random number generator is configured to indicate a number of sub-switches of the plurality of sub-switches to turn on in different charge-discharge periods.

7. The apparatus of claim 1, wherein:
respective switches of the one or more switches each comprise a plurality of sub-switches in parallel; and
the control circuit is configured to turn on a different number of sub-switches in different switches of the respective switches based on the random number generator in a same charge-discharge period.

8. The apparatus of claim 1, wherein the apparatus is provided in at least one of an integrated circuit, a System on Chip, a System in Package or a computing device.

9. An apparatus, comprising:
a substrate comprising a circuit;
one or more metal layers above the substrate;
a capacitor in a respective metal layer of the one or more metal layers, wherein the capacitor comprises inter-digitated first and second electrodes; and
vias coupled between the first and second electrodes and the circuit.

10. The apparatus of claim 9, wherein:
the first electrode comprises fingers coupled to a respective base portion;
the second electrode comprises fingers coupled to a respective base portion;
a first set of respective rows of vias are coupled to respective fingers of the first electrode; and
a second set of respective rows of vias are coupled to respective fingers of the second electrode.

11. The apparatus of claim 10, wherein the respective rows of the first set of respective rows alternate with the respective rows of the second set of respective rows.

12. The apparatus of claim 10, wherein the first set of respective rows of vias are coupled together, and the second set of respective rows of vias are coupled together.

13. The apparatus of claim 9, wherein adjacent fingers of the first and second electrodes are separated by an insulator.

14. The apparatus of claim 9, wherein the capacitor is a switched-capacitor of a voltage regulator.

15. A system, comprising:
a processor;
a resonant voltage regulator (VR) coupled to the processor, the resonant VR including a portion of a substrate and an inductor in a metal layer above the substrate; and
a control circuit coupled to the resonant voltage regulator to monitor a current of the resonant VR, wherein the control circuit is configured to determine whether the inductor is subject to electromagnetic probing based on the monitoring.

16. The system of claim 15, wherein:
the resonant VR comprises an inductor-inductor-capacitor (LLC) resonant VR including power switches, a resonant tank which includes a series resonant inductor, a parallel inductor, and a series resonant capacitor, a transformer and a diode rectifier; and
the control circuit is configured to monitor the current in a resistor in series with at least one of the series resonant inductor, the parallel inductor, or the series resonant capacitor.

17. The system of claim 15, wherein:
the resonant VR comprises a resonant tank which includes a series resonant inductor, a parallel inductor, and a series resonant capacitor; and
the control circuit is configured to monitor the current in the resonant tank.

18. The system of claim 15, wherein:
the resonant VR comprises an inductor-inductor-capacitor (LLC) resonant VR including power switches, a resonant tank which includes a series resonant inductor, a parallel inductor, and a series resonant capacitor, a transformer and a diode rectifier; and
the control circuit is configured to monitor the current in the resonant tank.

19. The system of claim 15, wherein the resonant VR comprises a current transformer, and the control circuit is configured to monitor the current in the current transformer.

20. The system of claim 15, wherein the control circuit is configured to trigger an alert if the monitoring indicates the inductor is subject to electromagnetic probing.
